(19) United States
(12) Patent Application Publication
(10) Pub. No.: US 2004/0066991 A1
(43) Pub. Date: Apr. 8, 2004

(54) High load capacity foil thrust bearings

(75) Inventor: Giridhari L. Agrawal, Simsbury, CT (US)

Correspondence Address: Wm. Tucker Griffith, McCormick, Paulding & Huber LLP, CityPlace II, 185 Asylum Street, Hartford, CT, 06103, US

(73) Assignee: R & D Dynamics Corporation, Bloomfield, CT

(21) Appl. No.: 10/608,970

(22) Filed: Jun. 27, 2003

Related U.S. Application Data
(60) Provisional application No. 60/415,907, filed on Oct. 3, 2002.

(51) Int. Cl. F16C 32/06; E02D 5/74

(52) U.S. Cl. 384/105

(57) ABSTRACT

The present invention provides a compliant foil thrust bearing that will remain parallel and compliant to a thrust runner operatively coupled to a rotating shaft of high speed rotating machinery over a broad range of size and operating environments and loads. The thrust bearing comprises a thrust bearing plate including a plurality of decoupled bearing segments, and a spring plate operatively engaging the thrust bearing plate, the spring plate including a plurality of decoupled spring plate segments. The respective decoupled segments are defined in part by a plurality of line of weakness, such as slits, slots, perforations, etched lines and grooves, circumaxially dispersed about the thrust bearing plate and the spring plate. A plurality of compliant foils are disposed on the surface of the thrust bearing plate, and a plurality of springs are disposed on the surface of the spring plate to improve the compliancy of the thrust bearing.

### CROSS-REFERENCE TO RELATED APPLICATION

This application claims the benefit of U.S. Provisional Application 60/415,907, filed Oct. 3, 2002, which is incorporated herein by reference.

### FIELD OF INVENTION

The present invention is generally related to thrust bearing technology, and is more specifically directed to compliant foil thrust bearings for use in high speed rotating machinery.

### BACKGROUND OF THE INVENTION

There is a great need for gas turbine engines and auxiliary power units providing improved performance, lower cost, better maintainability, and higher reliability. The Integrated High Performance Turbine Engine Technology program has provided significant advances in compressors, turbines, combustors, materials, generators, and other technologies. In order to make significant improvement in power vs. weight ratio, gas turbine engines and auxiliary power units must operate at higher speed and at higher temperature. In addition, the complicated oil lubrication system must be eliminated to facilitate higher temperature operation, and to reduce weight and cost. Magnetic bearings have shown great promise to meet goals of the Integrated High Performance Turbine Engine Technology program. However, in many applications, use of magnetic bearings is limited due to requirements of auxiliary bearings, cooling methods, weight and cost.

Foil air bearings do provide a promising alternative to magnetic bearings. Foil air bearings are successfully being used in air cycle machines of aircraft environmental control systems. Today, every new aircraft environmental control system, either military or civilian, invariably makes use of foil air bearings. Older aircraft are being converted from ball bearings to foil air bearings. Certain military aircraft air cycle machines used ball bearings up to 1982 and since then, are using foil air bearings. The reliability of foil air bearings in air cycle machines of commercial aircraft has been shown to be ten times that of previously used ball bearings in air cycle machines.

In spite of tremendous success of foil air bearings for air cycle machines, their use for gas turbine engines has been limited. This is due to the fact that gas turbine engines operate at higher temperatures and exhibit higher radial and axial loads. The radial loads are carried by foil journal bearings such as shown in U.S. Pat. No. 3,302,014 and discussed in ASME paper 97-GT-347 (June 1997) by Giri L. Agrawal entitled “Foil Air/Gas Bearing Technology—An Overview.” The axial loads are carried by foil thrust bearings such as shown in U.S. Pat. Nos. 3,382,014 and 4,462,700. In recent years, the load capacity of foil journal bearings has increased to a level which is satisfactory to carry radial loads of a typical gas turbine engine. However, the thrust load capacity requirement of a foil thrust bearing to be used for a gas turbine engine could be as much as four times that supplied by present day thrust bearing technology.

One solution to achieve higher thrust load capacity for a foil thrust bearing in a gas turbine engine is to increase the diameter of the thrust bearing. But larger diameters require greater radial space, increase stresses in the thrust runners, and increase power loss. Load capacity of a foil thrust bearing is also dependent on the flatness of the bearing. As flatness is maximized, load capacity increases. Due to various manufacturing tolerances and constraints, and also due to various operating conditions, keeping the thrust bearing very flat is a difficult task. The problem becomes more difficult as the size, and especially the diameter, of the thrust bearing increases.

The use of foil bearings in turbomachinery has several advantages:

Higher Reliability—Foil bearing machines are more reliable because there are fewer parts necessary to support the rotative assembly and there is no lubrication needed to feed the system. When the machine is in operation, the air/gas film between the bearing and the shaft protects the bearing foils from wear. The bearing surface is in contact with the shaft only when the machine starts and stops. During this time, a polymer coating, such as Teflon®, on the foils limits the wear.

Oil Free Operation—There is no contamination of the bearings from oil. The working fluid in the bearing is the system process gas which could be air or any other gas.

No Scheduled Maintenance—Since there is no oil lubrication system in machines that use foil bearings, there is never a need to check and replace the lubricant. This results in lower operating costs.

Environmental and System Durability—Foil bearings can handle severe environmental conditions such as shock and vibration loading. Any liquid from the system can easily be handled.

High Speed Operation—Compressor and turbine rotors have better aerodynamic efficiency at higher speeds, for example, 60,000 rpm or more. Foil bearings allow these machines to operate at the higher speeds without any of the limitations encountered with ball bearings. In fact, due to the aerodynamic action, they have a higher load capacity as the speed increases.

Low and High Temperature Capabilities—Many oil lubricants cannot operate at very high temperatures without breaking down. At low temperature, oil lubricants can become too viscous to operate effectively. As mentioned above, foil bearings permit oil free operation. Moreover, foil bearings operate efficiently at severely high temperatures, as well as at cryogenic temperatures.

### SUMMARY OF THE INVENTION

The present invention resides in a compliant foil thrust bearing, comprising a thrust bearing plate and a spring plate operatively engaging the thrust bearing plate. A plurality of foils are disposed on the surface of said thrust bearing plate, and a plurality of springs disposed on the surface of said spring plate. At least one of the thrust bearing plate and the spring plate includes a plurality of decoupled bearing segments defined in part by a plurality of lines of weakness circumaxially dispersed about the at least one of the thrust bearing plate and the spring plate.

The increased compliancy of the thrust bearings due to cutting or locally weakening the thrust bearing plates and the spring plates provides benefits not commonly associated with uncut or rigid thrust bearings:

a) Thrust bearing flatness can be maintained and such thrust bearings will remain parallel to the thrust runner over a range of operating environments and axial loads.

b) Thrust bearings with larger size and diameter than usual can be used while maintaining the desired flatness of the bearing.

c) Thrust bearing life is increased due to less foil wear.

d) Cut or locally weakened bearing plates and spring plates provide decoupled bearing segments that further increase compliancy and maintain flatness in thrust bearings.

### BRIEF DESCRIPTION OF DRAWINGS

FIG. 1 is a cross-sectional view of a stacked foil thrust bearing assembly in which cut or locally weakened thrust bearings in accordance with the present invention may be used.

FIG. 2 is a side view of a slitted thrust bearing plate in accordance with the present invention showing a plurality of circumaxially-distributed top foils.

FIG. 3 is a side view of a slitted spring plate in accordance with the present invention showing a plurality of circumaxially-distributed leaf springs.

FIG. 4 is a perspective view of a slitted thrust bearing assembly.

FIG. 5 is an exploded view of the slitted thrust bearing assembly in FIG. 4.

### DETAILED DESCRIPTION OF THE INVENTION AND PREFERRED EMBODIMENTS

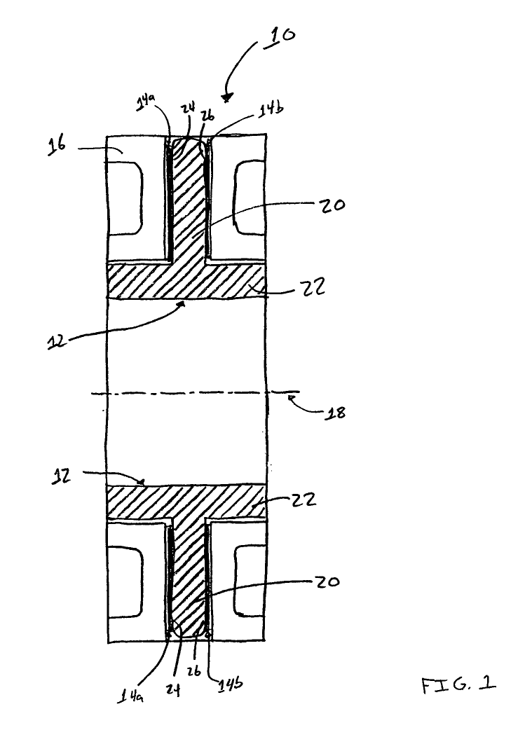

FIG. 1 shows a cross-sectional view of a stacked foil thrust bearing assembly, generally designated by reference numeral 10, and comprising a thrust runner 12 and thrust bearings 14a and 14b in accordance with the present invention. The bearing assembly 10 is positioned within a housing 16 and may form part of a rotating shaft coupled to a turbine or a rotor, the shaft extending through the housing 16 along a central axis of rotation 18. The shaft can be coupled to the turbine or rotor by interference fit, tie rod, or other known means. Preferably, the thrust runner 12 has an annular-shaped portion 20 extending radially from and circumscribing a hub 22. The hub 22 preferably forms a section of the shaft so that the thrust runner 12 is capable of rotation around the central axis 18 in coordination with the rotation of the shaft. Alternatively, the hub 22 may be operatively coupled to the shaft. For example, the hub 22 may slide over the shaft so that the thrust runner 12 is co-axially aligned with the shaft. The thrust runner 12 may also be a separate piece coupled to the hub 22 or the shaft.

Typically, the thrust runner 12 has first and second opposed axial sides, 24 and 26 respectively, which act as thrust-carrying surfaces. As shown, the first and second sides 24 and 26 are annular thrust-carrying surfaces circumscribing the hub 22. In a preferred embodiment of the present invention, at least one of the thrust bearings 14a or 14b is provided at a respective axial side 24 and 26 of the thrust runner 12. However, for unidirectional thrust, only one thrust bearing is needed at one axial side of the thrust runner 12. The positioning of that thrust bearing with respect to the thrust runner 12—i.e., adjacent one of the axial sides 24 or 26—is determined based on the direction of thrust and how the distribution of the axial loads will be best maximized.

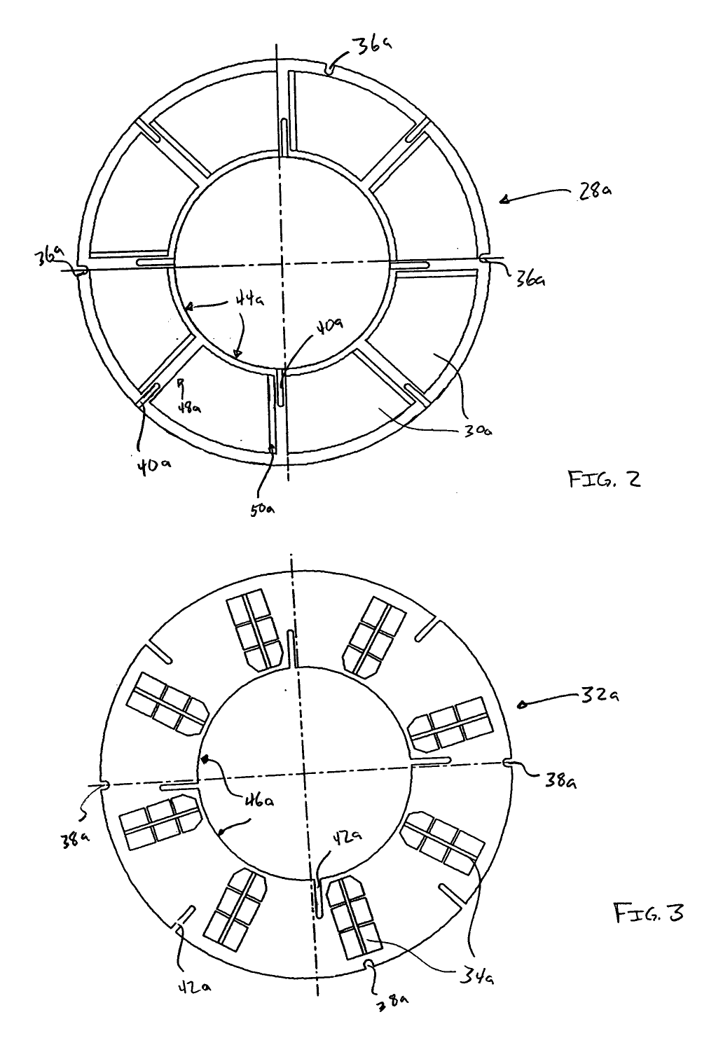

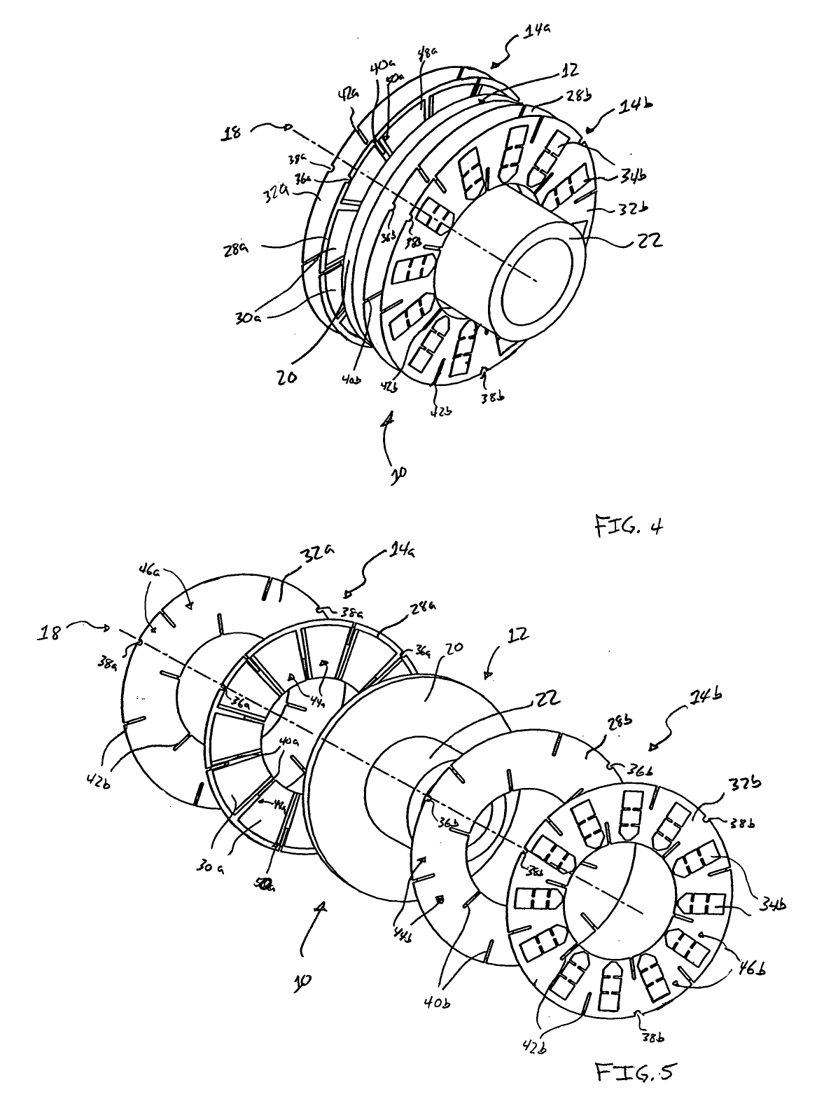

The thrust bearings 14a and 14b of the present invention are shown more particularly in FIGS. 4 and 5. The thrust bearing 14a is illustrated in FIGS. 2 and 3 and further discussed below. The thrust bearing 14b is similar in many respects to the thrust bearing 14a, with exception of the directional thrust designations, as discussed in more detail below. With respect to the thrust bearings 14a and 14b, like reference numerals succeeded by the letters a and b are used to indicate like elements.

The thrust bearing 14a includes a thrust bearing plate 28a (FIG. 2) with multiple top foils 30a, and a spring plate 32a (FIG. 3) with multiple leaf springs or flat springs 34a. Each thrust bearing 14a, 14b is preferably kept stationary within the housing 16 relative to the thrust runner 12 to aid in distribution of the axial loads. As shown in FIGS. 2 and 3, the thrust bearing plate 28a and the spring plate 32a are provided with respective pluralities of peripheral notches 36a and 38a. The notches 36a and 38a engage anti-rotation pins (not shown) in the housing 16 to hold the thrust bearing plate 28a and the spring plate 32a essentially stationary within the housing 16 while the shaft and the thrust runner 12 are rotating. Additionally, the housing 16 axially supports the spring plate 32a, which, in turn, axially supports the thrust bearing plate 28a.

The thrust bearing plate 28a and the spring plate 32a preferably have lines of weakness, designated by reference numerals 40a and 42a respectively, that define respective bearing segments 44a and 46a. Preferably, the thrust bearing plate 28a and the spring plate 32a are annular-shaped plates with each plate further having an outer diameter and an inner diameter. The bearing segments 44a and 46a defined by the respective lines of weakness 40a and 42a are preferably sector-shaped. As shown in the embodiments of FIGS. 2 and 3, the lines of weakness 40a and 42a are radially extending slits. Alternatively, the lines of weakness 40a and 42a may take the form of grooves, depressions, slots, etchings, perforations, holes or other mechanical cuts. The lines of weakness 40a and 42a allow the bearing segments 44a and 46a to be mechanically decoupled and thus make the thrust bearing plate 28a and the spring plate 32a more compliant than rigid, unweakened designs over a range of operating environments.

Though lines of weakness 40a and 42a are shown as being provided in both the thrust bearing plate 28a and the spring plate 32a of the thrust bearing 14a, the present invention is not limited in this regard as lines of weakness can be provided in just one of the thrust bearing plate 28a and the spring plate 32a without departing from the broader aspects of the present invention.

The lines of weakness 40a and 42a can have multiple orientations, shapes, sizes and locations within the thrust bearing plate 28a or the spring plate 32a. For example, FIGS. 2 and 3 show slits originating from both the inner diameter and the outer diameter of the plates in an alternating fashion. The lines of weakness 40a and 42a may be circumaxially dispersed about the plates 28a and 32a, either in a sequenced pattern or in a random pattern. Further, the bearing segments 44a defined by the lines of weakness 40a in the thrust bearing plate 28a may correspond to each of the top foils 30a—e.g., one top foil 30a per bearing segment 44a. Similarly, the bearing segments 46a defined by the lines of weakness 42a in the spring plate 32a may correspond to each of the leaf springs 34a—e.g., one leaf spring 34a per bearing segment 46a.

Thrust bearing plates and spring plates having lines of weakness 40a and 42a, as shown in FIGS. 2 and 3, have greater utility where flatness of the plates is desired or is likely to be a problem, such as in large diameter plates. Flat plates ensure that the plates will remain essentially parallel to the thrust runner 12 over a range of operating environments as well as over a range of axial loads and thrusts. The decouplable aspect provided by the lines of weakness 40a and 42a allows the structure of the housing 16 and the thrust runner 12 to substantially maintain the flatness of the thrust bearing plate 28a and spring plate 32a in the thrust bearing 14a without warpage, distortion and scraping.

Preferably, each thrust bearing 14a, 14b is centered on and is generally symmetric about the central axis 18. The thrust runner 12 and the axially disposed thrust bearings 14a, 14b support and distribute the axial load or thrust of the rotating machinery in the housing 16. Where thrust bearings are provided on both axial sides 24 and 26 of the thrust runner 12, one of the bearings (e.g., 14a), designated a clockwise thrust bearing, supports and distributes axial load in one direction, while the other thrust bearing (e.g., 14b) on the opposite axial side of the thrust runner 12, designated a counter-clockwise thrust bearing, supports and distributes axial load in the other direction. The clockwise or counter-clockwise designations are defined when viewing the thrust bearings 14a or 14b along the central axis 18 facing the thrust runner 12.

The top foils 30a on the thrust bearing plate 28 are typically made from flexible steel foil, such as Inconel®, and have a thickness between about 0.003 inches to about 0.015 inches. The top foils 30a are commonly secured to the axial side of the thrust bearing plate 28a facing the thrust runner 12, and are preferably welded along a leading edge 50a of the foils 30a to the thrust bearing plate 28a at circumaxial positions thereabout, while a trailing edge 48a of the foils 30a is free to flex. The leading edge 50a of each top foil 30a is defined with respect to the direction of rotation of the shaft relative to the top foils 30a. The top foils 30a are thus compliant with the thrust runner 12 during high-speed shaft rotation and, in conventional fashion, form a hydrodynamic lift to support the axial load. A polymer coating, such as Teflon®, is provided on the exposed outer face of the top foils 30a to protect them during start-up until air or gas film at the interface between the foils 30a and the thrust runner 12 takes over. Preferably, the top foils 30a are sector-shaped so as to maximize their compliance, while the respective thrust runner 12 is rotating about the central axis 18.

The spring plate 32a operatively engages the thrust bearing plate 28a within the housing 16. While the thrust bearing plate 28a and the spring plate 32a could be combined into one plate with the top foils 30a on one side and the springs 34a on the other side, the practice of using separate plates, as shown, is preferred. The top foils 30a are located on the axial side of the thrust bearing plate 28a opposite from the spring plate 32a. Preferably, the leaf springs 34a are disposed on the axial side of the spring plate 32a facing the housing 16, opposite from the thrust bearing plate 28a. The leaf springs 34a are usually welded to the spring plate 32a. While a specific design for the leaf springs 34a is shown, various leaf spring or flat spring designs may be used on the spring plate 32a without departing from the broader aspects of the present invention. The preferred axial positioning and arrangement of the thrust bearing plate 28a, the top foils 30a, the spring plate 32a and the leaf springs 34a of thrust bearing 14a with respect to the thrust runner 12, as well as the similar components for thrust bearing 14b, can be more clearly seen in FIGS. 4-5.

The foregoing description of embodiments of the present invention has been presented for the purpose of illustration and description, and is not intended to be exhaustive or to limit the present invention to the form disclosed. As will be recognized by those skilled in the pertinent art to which the present invention pertains, numerous changes and modifications may be made to the above-described embodiments without departing from the broader aspects of the present invention.

What is claimed is:

1. A compliant foil thrust bearing, comprising:
a thrust bearing plate;
a plurality of foils disposed on the surface of said thrust bearing plate;
a spring plate operatively engaging the thrust bearing plate;
a plurality of springs disposed on the surface of said spring plate; and
at least one of said thrust bearing plate and said spring plate including a plurality of decoupled bearing segments defined in part by a plurality of lines of weakness circumaxially dispersed about the at least one of said thrust bearing plate and said spring plate.

2. The compliant foil thrust bearing of claim 1, wherein the lines of weakness are slits.

3. The compliant foil thrust bearing of claim 1, wherein the lines of weakness are slots.

4. The compliant foil thrust bearing of claim 1, wherein the lines of weakness are perforations.

5. The compliant foil thrust bearing of claim 1, wherein the lines of weakness are etched lines.

6. The compliant foil thrust bearing of claim 1, wherein the lines of weakness are grooves.

7. The compliant foil thrust bearing of claim 1, wherein the lines of weakness are provided in the thrust bearing plate.

8. The compliant foil thrust bearing of claim 7, wherein each bearing segment includes at least one foil.

9. The compliant foil thrust bearing of claim 1, wherein the lines of weakness are provided in the spring plate.

10. The compliant foil thrust bearing of claim 9, wherein each bearing segment includes at least one spring.

11. The compliant foil thrust bearing of claim 1, wherein the thrust bearing plate and the spring plate are annular plates, each having an outer diameter and an inner diameter.

12. The compliant foil thrust bearing of claim 11, wherein the lines of weakness extend from the inner diameter.

13. The compliant foil thrust bearing of claim 11, wherein the lines of weakness extend from the outer diameter.

14. The compliant foil thrust bearing of claim 11, wherein the line of weakness extend from both the inner diameter and the outer diameter.

15. The compliant foil thrust bearing of claim 14, wherein the lines of weakness are circumaxially dispersed about the one of said thrust bearing plate and said spring plate in a sequenced pattern.

16. The compliant foil thrust bearing of claim 1, wherein lines of weakness are provided in the thrust bearing plate and the spring plate to define a plurality of decoupled bearing segments in each.

17. A compliant foil thrust bearing, comprising:
a thrust bearing plate;
a plurality of foils disposed on the surface of said thrust bearing plate;
a spring plate operatively engaging the thrust bearing plate; and
a plurality of springs disposed on the surface of said spring plate;
wherein each of said thrust bearing plate and said spring plate includes a plurality of decoupled bearing segments defined in part by a plurality of lines of weakness circumaxially dispersed about said thrust bearing plate and said spring plate.

18. The compliant foil thrust bearing of claim 17, wherein the lines of weakness provided in the thrust bearing plate and the spring plate are slits.

19. The compliant foil thrust bearing of claim 17, wherein the lines of weakness provided in the thrust bearing plate and the spring plate are slots.

20. The compliant foil thrust bearing of claim 17, wherein the lines of weakness provided in the thrust bearing plate and the spring plate are perforations.

21. The compliant foil thrust bearing of claim 17, wherein the lines of weakness provided in the thrust bearing plate and the spring plate are etched lines.

22. The compliant foil thrust bearing of claim 17, wherein the lines of weakness provided in the thrust bearing plate and the spring plate are grooves.

23. The compliant foil thrust bearing of claim 17, wherein the thrust bearing plate and the spring plate are annular plates, each having an outer diameter and an inner diameter; and
wherein the lines of weakness provided in the thrust bearing plate and the spring plate extend from at least one of the inner diameter and the outer diameter of the respective thrust bearing plate and spring plate.

24. The compliant foil thrust bearing of claim 23, wherein the lines of weakness provided in the thrust bearing plate and the spring plate extend from both the inner diameter and the outer diameter of the respective thrust bearing plate and spring plate.

25. A compliant foil thrust bearing, comprising:
a thrust bearing having a plurality of top foils disposed on a surface of said thrust bearing plate,
said thrust bearing plate including a plurality of decoupled bearing segments defined in part by a plurality of lines of weakness circumaxially dispersed about the thrust bearing plate.

26. The compliant foil thrust bearing of claim 25, wherein the lines of weakness are slits.

27. The compliant foil thrust bearing of claim 25, wherein the lines of weakness are slots.

28. The compliant foil thrust bearing of claim 25, wherein the lines of weakness are perforations.

29. The compliant foil thrust bearing of claim 25, wherein the lines of weakness are etched lines.

30. The compliant foil thrust bearing of claim 25, wherein the lines of weakness are grooves.
